(19) United States
(12) Patent Application Publication
(10) Pub. No.: US 2022/0250869 A1
(43) Pub. Date: Aug. 11, 2022

(54) MEDIA HEIGHT DETECTION METHOD, PRINTING APPARATUS

(71) Applicant: SEIKO EPSON CORPORATION, Tokyo (JP)

(72) Inventor: Yoshihiko MOMOSE, Shiojiri-Shi (JP)

(21) Appl. No.: 17/650,170

(22) Filed: Feb. 7, 2022

(30) Foreign Application Priority Data
Feb. 10, 2021 (JP) 2021-019691

(51) Int. Cl. B65H 43/06; G01B 11/06

(52) U.S. Cl. CPC B65H 43/06; G01B 11/0608

(57) ABSTRACT

A medium height detection method includes causing a plate-shaped member to be in contact with a predetermined position in a support portion, causing the support portion and the plate-shaped member to relatively move such that the plate-shaped member moves upward in a vertical direction until a detection signal indicates a non-contact state, then causing the support portion and the plate-shaped member to relatively move in a second direction, and performing control so as to cause the support portion and the plate-shaped member to relatively move such that the plate-shaped member moves upward until the detection signal indicates the non-contact state when the detection signal indicates a contact state, while causing the support portion and the plate-shaped member to relatively move until the plate-shaped member reaches a farther end portion from the predetermined position.

The present application is based on, and claims priority from JP Application Serial Number 2021-019691, filed Feb. 10, 2021, the disclosure of which is hereby incorporated by reference herein its entirety.

### BACKGROUND

### 1. Technical Field

The disclosure relates to a medium height detection method and a printing apparatus.

### 2. Related Art

There is heretofore known a UV printer that enables printing on various media such as acrylic, metal, plastic, and the like that are inherently difficult to print by using UV curing ink that cures upon irradiation with light in the ultraviolet region. The UV printer performs printing on media of various heights unlike the case of performing printing on a typical paper medium. Thus, a table on which a medium is placed has a structure that moves up and down by approximately from 0 to 200 mm depending on the thickness of the medium.

The distance between the printer head for discharging ink and the medium needs to be adjusted for printing. Accordingly, there is known a method that detects the height of the medium placed on the table using a height detection sensor. In this method, the height detection sensor needs to be reciprocatively moved several times at a table portion so as to be moved across the medium.

A technology is also disclosed in which a print height corresponding to a previously measured thickness of a medium is input to a printer in order to save time (JP 2013-1004 A).

Unfortunately, there is an issue, when the height detection sensor is used to detect the height of the medium, in that it is necessary, until the medium is recognized, to reciprocate the sensor in an oscillating manner without performing printing, resulting in time loss. There is also an issue, when the print height is input, in that the input is labor intensive and requires confirmation efforts to prevent erroneous input.

### SUMMARY

An aspect of resolving the above-described issues is a medium height detection method in a printing apparatus, the printing apparatus including a support portion that supports a medium, a discharge unit that discharges ink onto the medium supported by the support portion, a carriage that holds the discharge unit, a carriage rail that supports the carriage, a plate-shaped member, at least a part of which is located downward in a vertical direction of the carriage rail, the plate-shaped member extending in a first direction orthogonal to the vertical direction, a first moving unit that causes the support portion and the plate-shaped member to relatively move in the vertical direction, a second moving unit that causes the support portion and the plate-shaped member to relatively move in a second direction orthogonal to the vertical direction and the first direction, a plate-shaped member support portion that supports the plate-shaped member, a detection unit that outputs a detection signal configured to identify a contact state and a non-contact state of the plate-shaped member with any member other than the plate-shaped member support portion, or the medium, the method including causing the plate-shaped member to be in contact with a predetermined position in the support portion, then causing the support portion and the plate-shaped member to relatively move, until the detection signal indicates the non-contact state, such that the plate-shaped member moves upward in the vertical direction, then causing the support portion and the plate-shaped member to relatively move in the second direction until the plate-shaped member reaches, from the predetermined position in the support portion. a farther end portion in the second direction of the support portion from the predetermined position, and causing the support portion and the plate-shaped member to stop relatively moving each time the detection signal indicates the contact state while causing the support portion and the plate-shaped member to relatively move until the plate-shaped member reaches the farther end portion from the predetermined position, then causing the support portion and the plate-shaped member to relatively move, until the detection signal indicates the non-contact state, such that the plate-shaped member moves upward, and then controlling the first moving unit and the second moving unit so as to cause the support portion and the plate-shaped member to relatively move in the second direction such that the plate-shaped member approaches the farther end portion.

Another aspect of resolving the above-described issues is a printing apparatus, the printing apparatus including a support portion that supports a medium, a discharge unit that discharges ink onto the medium supported by the support portion, a carriage that holds the discharge unit, a carriage rail that supports the carriage, a plate-shaped member, at least a part of which is located downward in a vertical direction of the carriage rail, the plate-shaped member extending in a first direction orthogonal to the vertical direction, a first moving unit that causes the support portion and the plate-shaped member to relatively move in the vertical direction, a second moving unit that causes the support portion and the plate-shaped member to relatively move in a second direction orthogonal to the vertical direction and the first direction, a plate-shaped member support portion that supports the plate-shaped member, a detection unit that outputs a detection signal configured to identify a contact state and a non-contact state of the plate-shaped member with any member other than the plate-shaped member support portion, or the medium, and a control unit configured to control the first moving unit and the second moving unit, in which the control unit is configured to cause the plate-shaped member to be in contact with a predetermined position in the support portion, to then cause the support portion and the plate-shaped member to relatively move, until the detection signal indicates the non-contact state, such that the plate-shaped member moves upward in the vertical direction, to then cause the support portion and the plate-shaped member to relatively move in the second direction until the plate-shaped member reaches, from the predetermined position in the support portion, a farther end portion in the second direction of the support portion from the predetermined position, and to cause the support portion and the plate-shaped member to stop relatively moving each time the detection signal indicates the contact state while causing the support portion and the plate-shaped member to relatively move until the plate-shaped member reaches the farther end portion from the predetermined position, to then cause the support portion and the plate-shaped member to relatively move, until the detection signal indicates the non-contact state, such that the plate-shaped member moves upward, and to then control the first moving unit and the second moving unit so as to cause the support portion and the plate-shaped member to relatively move in the second direction such that the plate-shaped member approaches the farther end portion.

### BRIEF DESCRIPTION OF THE DRAWINGS

FIG. 1 is an explanatory diagram of a medium and a printing apparatus including a detection unit that detects a height of the medium.

FIG. 2 is an explanatory diagram illustrating a modified example in which a detection unit is disposed downward of a carriage rail.

FIG. 3 is a side view of a detection unit.

FIG. 4 is an explanatory diagram of a height detection operation by a detection unit.

FIG. 5 is a block diagram illustrating an electrical configuration of a printing apparatus.

FIG. 6 is an explanatory diagram of an operation for detecting a side face.

FIG. 7 is an explanatory diagram of an operation for detecting a side face.

FIG. 8 is an explanatory diagram of an operation for detecting an upper face.

FIG. 9 is an explanatory diagram of an operation for detecting a side face of a support portion that supports a medium.

FIG. 10 is an explanatory diagram of an operation for detecting an upper face of a support portion.

FIG. 11 is an explanatory diagram of an operation for detecting a side face of a medium.

FIG. 12 is an explanatory diagram of an operation for detecting an upper face of a medium.

FIG. 13 is an explanatory diagram of an operation for detecting an upper face of a medium.

FIG. 14 is an explanatory diagram of an operation for detecting whether convex portions are present at an upper face of a medium.

FIG. 15 is a flowchart of a medium height detection method.

### DESCRIPTION OF EXEMPLARY EMBODIMENTS

Embodiments of the present disclosure will be described below with reference to the accompanying drawings.

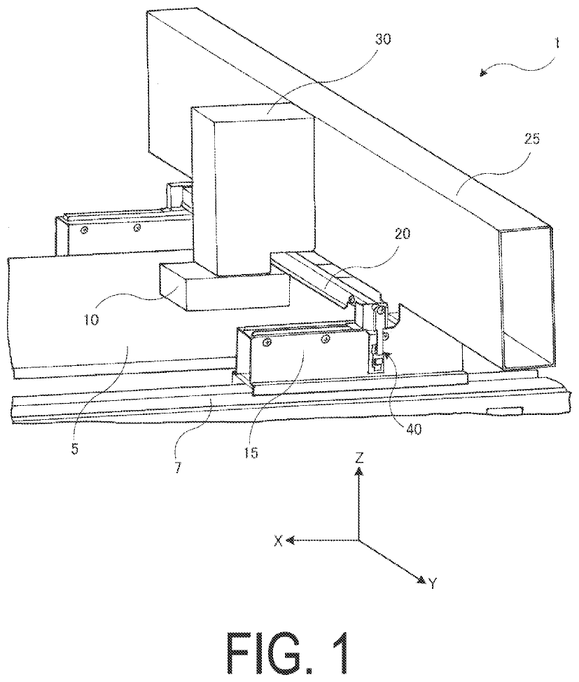

FIGS. 1 to 15 illustrate one example of the embodiments, in which portions denoted by an identical numeral indicate an identical portion in the drawings. Note that some configurations are appropriately omitted in the figures to simplify the drawings. Further, the size, shape, thickness, and the like of the member are expressed exaggerated as appropriate.

FIG. 1 is an overall view illustrating a printing apparatus 1 according to the first embodiment. The printing apparatus 1 includes a detection unit 40 that detects the height of a medium 10. The printing apparatus 1 includes a support portion 5 that supports the medium 10 from vertically downward to upward, a print head 71 as a discharge unit that discharges ink onto the medium 10 supported by the support portion 5, and a carriage 30 that holds the discharge unit. The printing apparatus 1 also includes a carriage rail 25 that supports the carriage 30, a slider 15 that supports the carriage rail 25, and a pair of guide rails 7 that are provided on both sides of the support portion 5 and guides the movement of the slider 15. In the first embodiment, the carriage rail 25 is described as one example of a method for supporting a carriage.

The printing apparatus 1 includes the detection unit 40 that detects the height of the medium 10. Specifically, the detection unit 40 includes a plate-shaped member 20 of which at least a part is located downward in the vertical direction at the carriage rail 25 and extending in a first direction orthogonal to the vertical direction, and a pivoting shaft 37 that pivotally supports the plate-shaped member 20. The detection unit 40 also includes a plate-shaped member support portion 23 that supports the pivoting shaft 37 and makes the pivoting shaft 37 fixed to the slider 15. The detection unit 40 outputs a detection signal configured to identify a contact state and a non-contact state of the plate-shaped member 20 with any member other than the plate-shaped member support portion 23, or the medium 10.

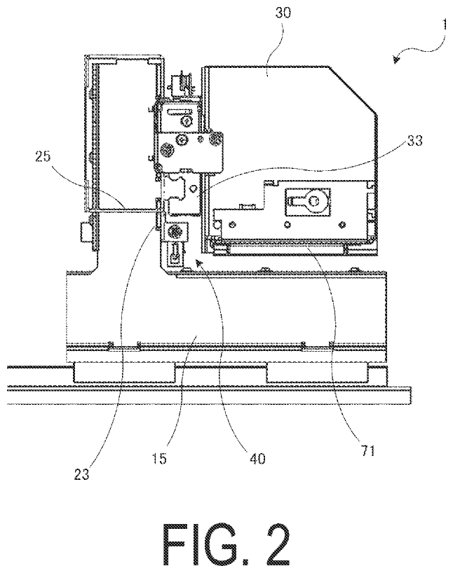

FIG. 2 is an explanatory diagram of a modified example of the detection unit 40. In the modified example, the detection unit 40 is located downward of an LM guide (Trademark) 33 that configures the carriage 30 movable with respect to the carriage rail 25. The plate-shaped member support portion 23 may also be fixed to the carriage rail 25 and be moved integrally with the carriage rail 25.

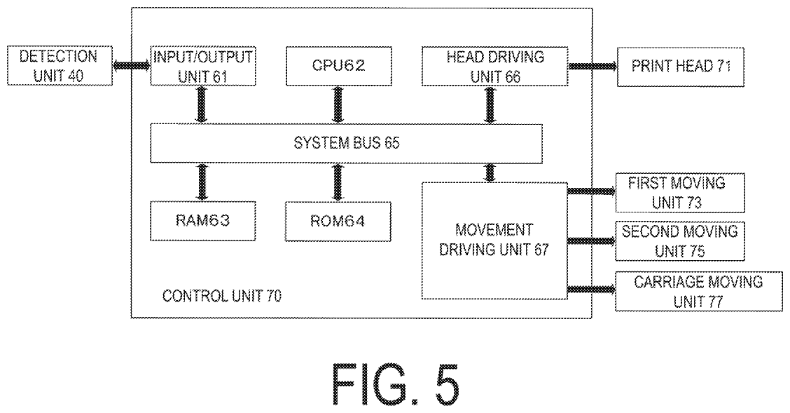

The printing apparatus 1 includes a first moving unit 73 that causes the support portion 5 and the plate-shaped member 20 to relatively move in the vertical direction and a second moving unit 75 that causes the support portion 5 and the plate-shaped member 20 to move in a second direction orthogonal to the vertical direction and the first direction, as illustrated in FIG. 5 described later. The printing apparatus 1 also includes a carriage moving unit 77 that causes the carriage 30 to move in the first direction along the carriage rail 25. The printing apparatus 1 includes a control unit 70 configured to control the first moving unit 73 and the second moving unit 75. The control unit 70 controls the discharge of ink from the discharge unit. In the first embodiment, the slider 15 and the pair of guide rails 7 are descried as one example of the second moving unit 75, and the LM guide (Registered Trademark) 33 is descried as one example of the carriage moving unit 77.

Here, the positive orientation in a Z axis direction in FIG. 1 corresponds to an upward orientation in the vertical direction. Also, a Y axis direction in FIG. 1 corresponds to the first direction. An X axis direction in FIG. 1 corresponds to the second direction.

Here, it is preferred for the plate-shaped member 20 to be provided extending across the entire range in which printing can be performed in the first direction of the support portion 5.

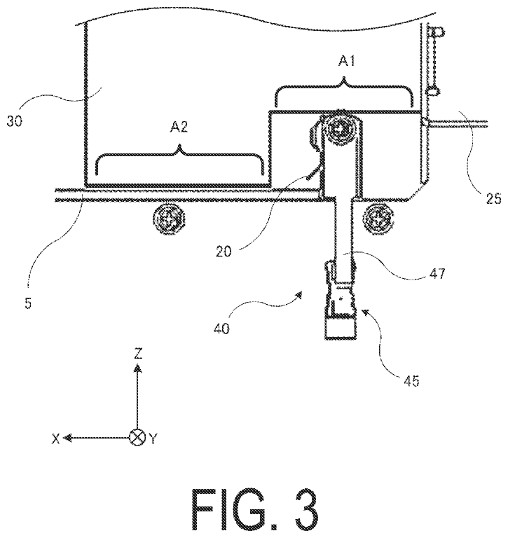

FIG. 3 is a side view of the detection unit 40. The detection unit 40 is disposed vertically downward of the carriage 30. The carriage 30 includes a first region A1 located close to the carriage rail 25 and a second region A2 located farther from the carriage rail 25 than the first region A1. The bottom portion in the first region A1 is located farther from the support portion 5 than the bottom portion in the second region A2. The nozzle face of the discharge unit is located in the second region A2, and the plate-shaped member 20 is disposed vertically downward of the bottom portion in the first region A1.

The detection unit 40 includes a light-shielding portion 47 that moves integrally with the plate-shaped member 20, and a photo sensor 45 that detects the movement of the light-shielding portion 47. Specifically, the light-shielding portion 47 includes, for example, a convex portion protruding in the Y axis direction, and the detection unit 40 detects whether the plate-shaped member 20 is in contact with a side face of the medium 10 or the like depending on whether the convex portion blocks between a light source included in the detection unit 40 and the photo sensor 45.

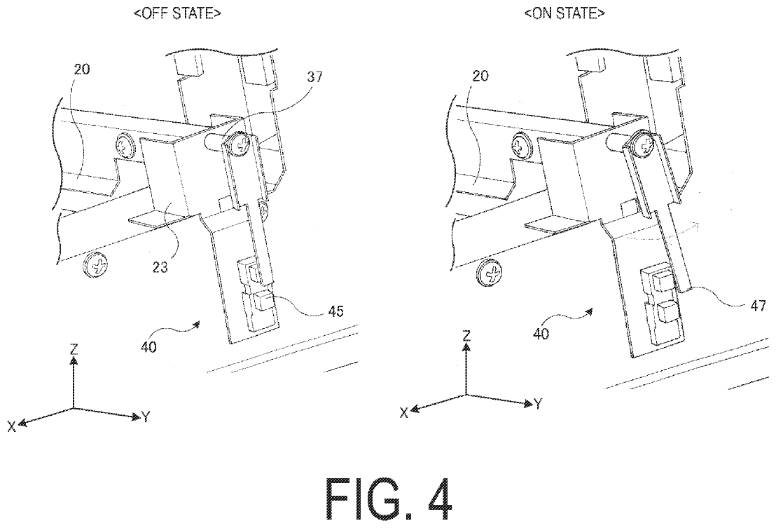

FIG. 4 is an explanatory diagram of a height detection operation by the detection unit 40. In FIG. 4, the figure on the left is a diagram illustrating an OFF state, specifically, a state where a medium or the like is not detected. The light-shielding portion 47 does not move when the plate-shaped member 20 is in a state of being not in contact with the medium 10 or a side face of the support portion 5, and the detection unit 40 outputs, to the control unit 70, a signal indicating that the plate-shaped member 20 is in the non-contact state.

In FIG. 4, the figure on the right is a diagram illustrating an ON state, specifically, a state where a medium or the like is detected. The light-shielding portion 47 pivotally moves about the pivoting shaft 37 as the fulcrum and thus moves in the arrow direction in the figure when the plate-shaped member 20 is in a state of being in contact with the medium 10 or a side face of the support portion 5. Then the detection unit 40 outputs, to the control unit 70, a signal indicating that the detection unit 40 is in the contact state.

FIG. 5 is a block diagram illustrating an electrical configuration of the printing apparatus 1. The control unit 70 is provided with a CPU 62 that manages control of the entirety of the printing apparatus 1. The CPU 62 is coupled via a system bus 65 with a ROM 64 that stores various types of control programs and the like to be implemented by the CPU 62 and with a RAM 63 configured to temporarily store data. The CPU 62 is also coupled via the system bus 65 with a head driving unit 66 for driving the print head 71. The CPU 62 is also coupled via the system bus 65 with a movement driving unit 67. The movement driving unit 67 is then coupled with the carriage moving unit 77 for causing the carriage 30 provided with the print head 71, and a first moving unit 73 provided to cause the support portion 5 that supports a medium and the plate-shaped member 20 to relatively move in the vertical direction. The movement driving unit 67 is also coupled with the second moving unit 75 that causes the support portion 5 and the plate-shaped member 20 to relatively move in the vertical direction and in the second direction orthogonal to the first direction. The CPU 62 is further coupled via the system bus 65 with an input/output unit 61. The input/output unit 61 is then coupled to the detection unit 40. The control unit 70 thus configured controls the entirety of the printing apparatus 1.

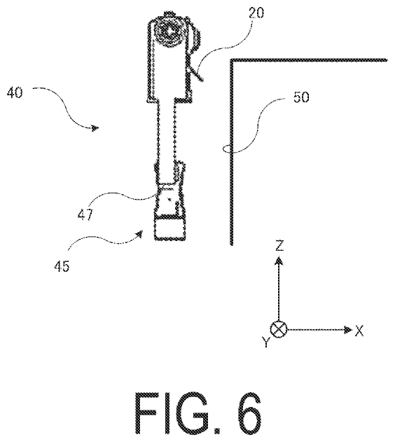

FIGS. 6 to 8 are explanatory diagrams of operations for detecting a side face and the upper face.

In FIG. 6, the plate-shaped member 20 included in the detection unit 40 is in a state of being not in contact with a side face 50. In this case, the light-shielding portion 47 blocks between the photo sensor 45 and a non-illustrated light source, and the detection unit 40 outputs, to the control unit 70, a signal indicating that the plate-shaped member 20 is in a state of being not in contact with a side face. The control unit 70 then causes the detection unit 40 and the side face 50 to relatively move close to each other in the X axis direction in FIG. 6.

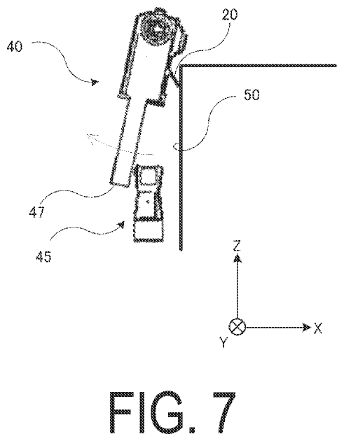

In FIG. 7, the plate-shaped member 20 included in the detection unit 40 is in a state of being in contact with the side face 50. In this case, the light-shielding portion 47 does not block between the photo sensor 45 and the non-illustrated light source, and the detection unit 40 outputs, to the control unit 70, a signal indicating that the plate-shaped member 20 is in a state of being in contact with a side face. The control unit 70 then causes the detection unit 40 to relatively move upward in the Z axis direction in FIG. 7.

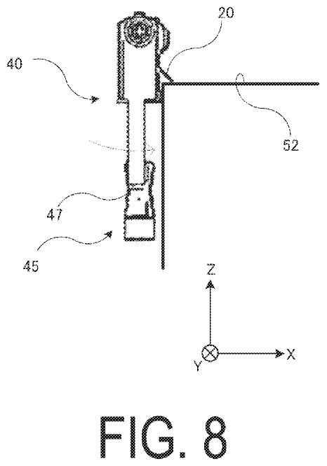

In FIG. 8, the plate-shaped member 20 included in the detection unit 40 reaches the height of an upper face 52 and is not in contact with the side face 50. In this case, the light-shielding portion 47 blocks between the photo sensor 45 and the non-illustrated light source, and the detection unit 40 outputs, to the control unit 70, a signal indicating that the plate-shaped member 20 is not in contact with a side face. Then, the control unit 70 causes the detection unit 40 and the side face 50 to relatively move in the positive orientation in the X axis direction in FIG. 8.

The operations in FIGS. 6 to 8 can detect the steps in the Z axis direction, specifically, the heights of the support portion 5 and the medium 10.

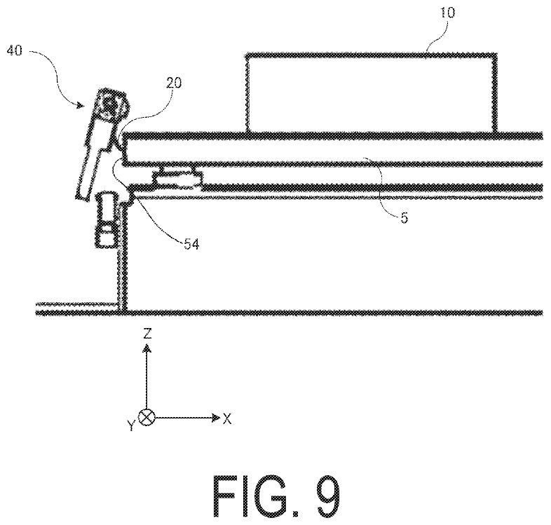

FIGS. 9 to 14 are explanatory diagrams of operations for detecting positions of side faces and the upper faces of the medium 10 and the support portion 5 that supports the medium 10 to detect the heights of the support portion 5 and the medium 10.

FIG. 9 is an explanatory diagram of an operation for detecting a side face 54 of the support portion 5 that supports the medium 10.

First, the control unit 70 causes the carriage 30 to retract to the retracted position.

The control unit 70 causes the plate-shaped member 20 to be in contact with a predetermined position in the support portion 5. The control unit 70 then controls the first moving unit 73 (not illustrated), and causes the support portion 5 and the plate-shaped member 20 to relatively move, until a signal indicating the non-contact state is output from the detection unit 40, such that the plate-shaped member 20 moves upward in the vertical direction.

Specifically, when the plate-shaped member 20 is in contact with the side face 54 of the support portion, the light-shielding portion 47 of the detection unit 40 moves and the control unit 70 detects a contact with the side face 54 of the support portion. The control unit 70 controls the first moving unit 73 to cause the support portion 5 to move downward in the vertical direction, that is, in the negative orientation in the Z axis direction in FIG. 9.

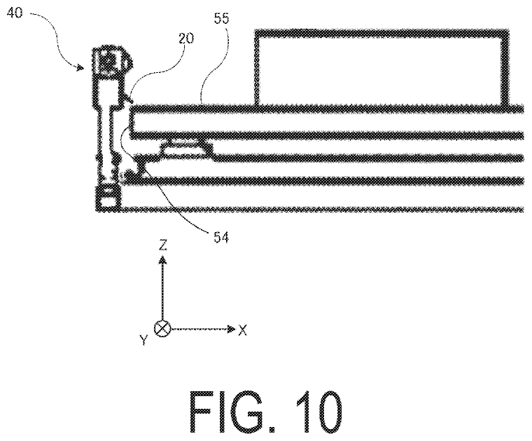

FIG. 10 is an explanatory diagram of an operation for detecting an upper face of a support portion. The control unit 70, when the detection unit 40 outputs a signal indicating that the detection unit 40 is in the non-contact state, causes the support portion 5 to stop moving in the negative orientation in the Z axis direction. It is desirable to store the position at which the movement is stopped as a height H1 of the support portion 5.

Here, the control unit 70 increases, by a predetermined value, the distance between the support portion 5 and the plate-shaped member 20. For example, the value ranges from 1 to 2 mm. This is because the plate-shaped member 20 does not relatively move while rubbing an upper face 55 of the support portion 5.

The control unit 70 then controls the second moving unit 75 to cause the support portion 5 and the plate-shaped member 20 to relatively move until the plate-shaped member reaches, from the predetermined position in the support portion 5, a farther end portion in the second direction of the support portion 5 from the predetermined position. Specifically, the predetermined position is the side face 54 of the support portion 5.

Here, the second direction is the X axis direction in FIG. 10.

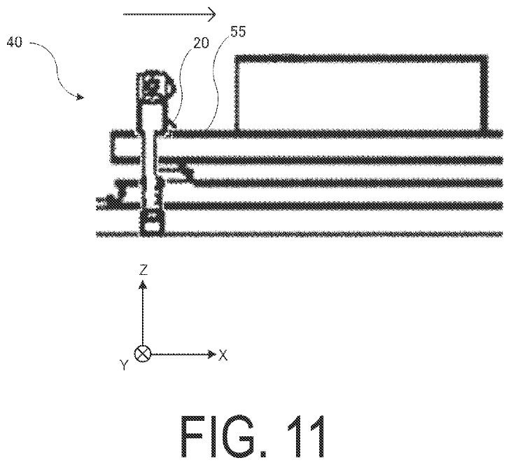

The control unit 70 causes the support portion 5 and the plate-shaped member 20 to stop relatively moving each time the detection signal indicates the contact state while causing the support portion 5 and the plate-shaped member 20 to relatively move until the plate-shaped member 20 reaches, from the predetermined position in the support portion 5, the farther end portion of the support portion 5 in the arrow orientation in FIG. 11.

Specifically, the control unit 70 controls the second moving unit 75 to cause the support portion 5 and the plate-shaped member 20 to relatively move until the plate-shaped member 20 is in contact with a side face 56 of the medium 10.

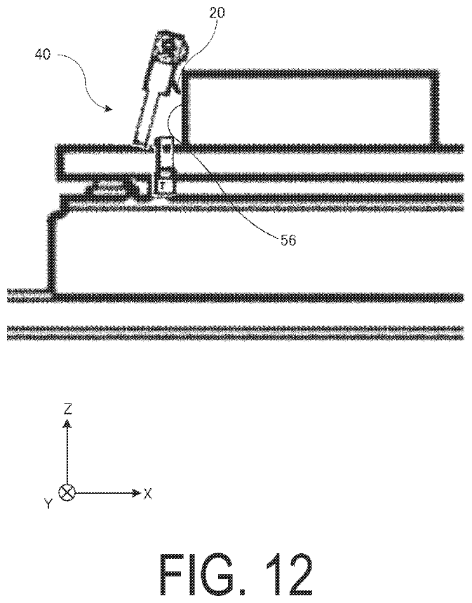

The control unit 70 then causes the plate-shaped member 20 to move upward until the control unit 70 receives a detection signal indicating the non-contact state, as illustrated in FIG. 12. That is, the control unit 70 controls the first moving unit 73 to cause the support portion 5 and the plate-shaped member 20 to relatively move.

The control unit 70 controls the first moving unit 73 to move the support portion 5 downward in the vertical direction, that is, in the negative orientation in the Z axis direction in FIG. 12.

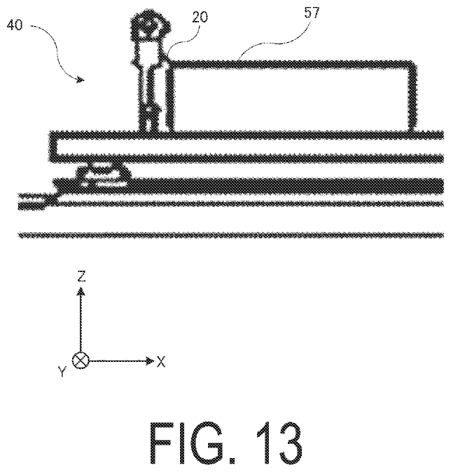

FIG. 13 is an explanatory diagram of an operation for detecting an upper face of the medium 10. The control unit 70, when the detection unit 40 outputs a detection signal indicating the non-contact state, causes the detection unit 40 to stop moving in the positive orientation in the Z axis direction. It is desirable to store the position at which the movement is stopped as a height H2 of the medium 10.

Here, the control unit 70 increases, by a predetermined value, the distance between the upper face of the medium 10 and the plate-shaped member 20. For example, the value ranges from 1 to 2 mm. This is because the plate-shaped member 20 does not relatively move while rubbing an upper face 57 of the medium 10.

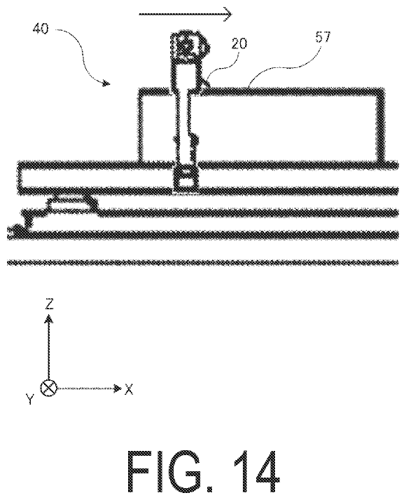

The control unit 70 further controls the second moving unit 75 so as to cause the support portion 5 and the plate-shaped member 20 to relatively move in the second direction so that the plate-shaped member 20 approaches the farther end portion of the support portion 5. Specifically, the control unit 70 causes the support portion 5 and the plate-shaped member 20 to relatively move in the arrow direction in FIG. 14.

The control unit 70 is configured to detect the heights of the support portion 5 and the medium 10 by performing the above-described operations each time the detection signal indicates the contact state.

It is desirable, at the time when finally performing setting for printing, to reduce the height of the support portion 5 by at least the difference in the height direction between the plate-shaped member 20 and the discharge unit.

The printing apparatus 1 according to the first embodiment includes the support portion 5 that supports the medium 10, the discharge unit that discharges ink onto the medium 10 supported by the support portion 5, the carriage 30 that holds the discharge unit, the carriage rail 25 that supports the carriage 30, the plate-shaped member 20, extending in the first direction orthogonal to the vertical direction, of which at least a part is located downward in the vertical direction of the carriage rail 25, the first moving unit 73 that causes the support portion 5 and the plate-shaped member 20 to relatively move in the vertical direction, the second moving unit 75 that causes the support portion 5 and the plate-shaped member 20 to relatively move in the second direction orthogonal to the vertical direction and the first direction, the plate-shaped member support portion 23 that supports the plate-shaped member 20, and the detection unit 40 that outputs the detection signal configured to identify a contact state and a non-contact state of the plate-shaped member 20 with any member other than the plate-shaped member support portion 23, or the medium 10, and the control unit 70 configured to control the first moving unit 73 and the second moving unit 75, in which the control unit 70 is configured to cause the plate-shaped member 20 to be in contact with the predetermined position in the support portion 5, to then cause the support portion 5 and the plate-shaped member 20 to relatively move, until the detection signal indicates the non-contact state, such that the plate-shaped member 20 moves upward in the vertical direction, to then cause the support portion 5 and the plate-shaped member 20 to relatively move in the second direction until the plate-shaped member 20 reaches, from the predetermined position in the support portion 5, the farther end portion, in the second direction of the support portion 5, from the predetermined position, and causing the support portion 5 and the plate-shaped member 20 to stop relatively moving each time the detection signal indicates the contact state while causing the support portion 5 and the plate-shaped member 20 to relatively move until the plate-shaped member 20 reaches the farther end portion from the predetermined position, to then cause the support portion 5 and the plate-shaped member 20 to relatively move, until the detection signal indicates the non-contact state, such that the plate-shaped member 20 moves upward, and to then control the first moving unit 73 and the second moving unit 75 so as to cause the support portion 5 and the plate-shaped member 20 to relatively move in the second direction such that the plate-shaped member 20 approaches the farther end portion.

According to the printing apparatus 1 thus configured, it is not necessary to cause the detection unit to reciprocatively move until the detection unit is abutted against the medium 10, thereby achieving an effect that the time until the height is detected is shortened. Also, it is not necessary to input the height of the medium 10, thus it is possible to save time for confirmation for preventing erroneous input, for example.

In the printing apparatus 1 according to the first embodiment, the first moving unit 73 causes the support portion 5 to move in the vertical direction, and causes, at the time when causing the support portion 5 and the plate-shaped member 20 to relatively move, the support portion 5 to move downward in the vertical direction such that the plate-shaped member 20 moves upward.

According to the printing apparatus 1 thus configured, it is also possible to measure beforehand the height of the support portion 5 that supports the medium 10, thus the printing time can be shortened even when the thickness of the medium 10 is thin, thereby achieving an excellent effect that a height detection is facilitated.

In the printing apparatus 1 according to the first embodiment, the second moving unit 75 causes the plate-shaped member support portion 23 to move in the second direction, and causes, at the time when causing the support portion 5 and the plate-shaped member 20 to relatively move in the second direction until the plate-shaped member 20 reaches, from the predetermined position in the support portion 5, the farther end portion, in the second direction of the support portion 5, from the predetermined position, the plate-shaped member support portion 23 to move in the second direction from the predetermined position to the farther end portion.

According to the printing apparatus 1 thus configured, an effect is achieved that the height of the location that is highest from the support portion 5 can be detected for the medium 10 having convex-concave portions at the upper face.

In the printing apparatus 1 according to the first embodiment, the carriage 30 includes, in the second direction, the first region A1 close to the carriage rail 25 and the second region A2 farther from the carriage rail 25 than the first region A1, where the bottom portion in the first region A1 is located farther from the support portion 5 than the bottom portion in the second region A2, the nozzle face of the discharge unit is located in the second region A2, and the plate-shaped member 20 is located downward in the vertical direction of the bottom portion in the first region A1.

According to the printing apparatus 1 thus configured, the detection unit 40 that detects the height can be brought into proximity with the carriage rail 25 that supports the carriage 30, thereby achieving an effect that the height of the medium 10 can be detected at a high speed.

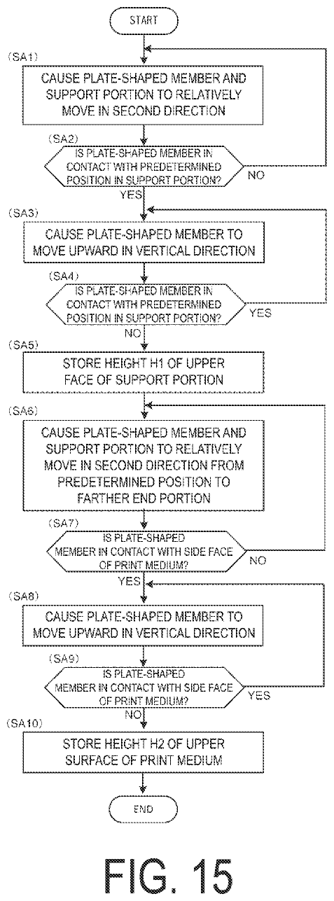

FIG. 15 is a flowchart of a medium height detection method according to the second embodiment.

First, the control unit 70 of the printing apparatus 1 causes the plate-shaped member 20 and the support portion 5 to relatively move in the second direction (step SA1). The control unit 70 then determines whether the plate-shaped member 20 is in contact with the predetermined position in the support portion 5 based on the movement of the plate-shaped member 20 (step SA2). The control unit 70, when determining that the plate-shaped member 20 is in the contact state (step SA2: YES), controls the first moving unit 73 to cause the plate-shaped member 20 to move vertically upward (step SA3). The control unit 70 determines whether the plate-shaped member 20 is in contact with the predetermined position in the support portion 5 based on the movement of the plate-shaped member 20 (step SA4). The control unit 70, when determining that the plate-shaped member 20 is in a state of being not in contact with the predetermined position in the support portion 5 (step SA4: NO), stores the position of the plate-shaped member 20 at that state as the height H1 of the upper face 55 of the support portion (step SA5).

When the control unit 70 determines that the plate-shaped member 20 is in a state of being not in contact with the predetermined position in the support portion 5 (step SA2: NO), the process returns to step SA1. Also, when the control unit 70 determines that the plate-shaped member 20 is in a state of being in contact with the predetermined position in the support portion 5 (step SA4: YES), the process returns to step SA3.

The control unit 70 then controls the second moving unit 75 to cause the plate-shaped member 20 and the support portion 5 to relatively move in the second direction from the predetermined position to the farther end portion of the support portion 5 (step SA6). The control unit 70 subsequently determines whether the plate-shaped member 20 is in contact with a side face of the medium 10 based on the movement of the plate-shaped member 20 (step SA7). The control unit 70, when determining that the plate-shaped member 20 is in a state of being in contact with a side face of the medium 10 (step SA7: YES), causes the plate-shaped member 20 to move upward in the vertical direction (step SA8). The control unit 70 then determines whether the plate-shaped member 20 is in contact with a side face of the medium 10 based on the movement of the plate-shaped member 20 (step SA9). The control unit 70, when determining that the plate-shaped member 20 is in a state of being not in contact with a side face of the medium 10 (step SA9: NO), stores the position of the plate-shaped member 20 at that state as the height H2 of the upper face 57 of the medium (step SA10).

When the control unit 70 determines that the plate-shaped member 20 is in a state of being not in contact with a side face of the medium 10 (step SA7: NO), the process returns to step SA6. Also, when the control unit 70 determines that the plate-shaped member 20 is in a state of being in contact with a side face of the medium 10 (step SA9: YES), the process returns to step SA8.

The medium height detection method according to the second embodiment is a medium height detection method in a printing apparatus, the printing apparatus including the support portion 5 that supports the medium 10, the discharge unit that discharges ink onto the medium 10 supported by the support portion 5, the carriage 30 that holds the discharge unit, the carriage rail 25 that supports the carriage 30, the plate-shaped member 20 of which at least a part is located downward in the vertical direction of the carriage rail 25, the plate-shaped member 20 extending in the first direction orthogonal to the vertical direction, the first moving unit 73 that causes the support portion 5 and the plate-shaped member 20 to relatively move in the vertical direction, the second moving unit 75 that causes the support portion 5 and the plate-shaped member 20 to relatively move in the second direction orthogonal to the vertical direction and the first direction, the plate-shaped member support portion 23 that supports the plate-shaped member 20, and the detection unit 40 that outputs the detection signal configured to identify a contact state and a non-contact state of the plate-shaped member 20 with any member other than the plate-shaped member support portion 23, or the medium 10, the method including causing the plate-shaped member 20 to be in contact with the predetermined position in the support portion 5, then causing the support portion 5 and the plate-shaped member 20 to relatively move, until the detection signal indicates the non-contact state, such that the plate-shaped member 20 moves upward in the vertical direction, then causing the support portion 5 and the plate-shaped member 20 to relatively move in the second direction until the plate-shaped member 20 reaches, from the predetermined position in the support portion 5, the farther end portion, in the second direction of the support portion 5, from the predetermined position, and causes the support portion 5 and the plate-shaped member 20 to stop relatively moving each time the detection signal indicates the contact state while causing the support portion 5 and the plate-shaped member 20 to relatively move until the plate-shaped member 20 reaches the farther end portion from the predetermined position, then causing the support portion 5 and the plate-shaped member 20 to relatively move, until the detection signal indicates the non-contact state, such that the plate-shaped member 20 moves upward, and then controlling the first moving unit 73 and the second moving unit 75 so as to cause the support portion 5 and the plate-shaped member 20 to relatively move in the second direction such that the plate-shaped member 20 approaches the farther end portion.

According to the medium height detection method according to the above-described second embodiment, an excellent effect is achieved that the height of the medium 10 can be accurately and rapidly detected.

Note that the printing apparatus and the medium height detection method of the present disclosure are not limited to the above-described embodiments, and it goes without saying that various modifications may be added without departing from the gist of the present disclosure.

The processing units in the flowchart illustrated in FIG. 15 are obtained by dividing processing in accordance with a main processing content to facilitate the understanding of the processing of the control unit 70. Thus, the present disclosure is not limited by a method for dividing the processing into the processing units and a name of the processing units.

The processing of the control unit 70 may be divided into further more processing units in accordance with the processing content, and may be divided such that one processing unit contains furthermore processings. Also, the order of the processings in the above-described flowchart is not limited to the illustrated examples.

What is claimed is:

1. A medium height detection method for a printing apparatus,
the printing apparatus comprising:
a support portion that supports a medium;
a discharge unit that discharges ink onto the medium supported by the support portion;
a carriage that holds the discharge unit;
a carriage rail that supports the carriage;
a plate-shaped member, at least a part of which is located downward in a vertical direction of the carriage rail, the plate-shaped member extending in a first direction orthogonal to the vertical direction;
a first moving unit that causes the support portion and the plate-shaped member to relatively move in the vertical direction;
a second moving unit that causes the support portion and the plate-shaped member to relatively move in a second direction orthogonal to the vertical direction and the first direction;
a plate-shaped member support portion that supports the plate-shaped member, and
a detection unit that outputs a detection signal configured to identify a contact state and a non-contact state of the plate-shaped member with any member other than the plate-shaped member support portion, or the medium,
the method including
causing the plate-shaped member to be in contact with a predetermined position in the support portion,
then causing the support portion and the plate-shaped member to relatively move, until the detection signal indicates the non-contact state, such that the plate-shaped member moves upward in the vertical direction,
then causing the support portion and the plate-shaped member to relatively move in the second direction until the plate-shaped member reaches, from the predetermined position in the support portion, a farther end portion, in the second direction of the support portion, from the predetermined position, and causing the support portion and the plate-shaped member to stop relatively moving each time the detection signal indicates the contact state while causing the support portion and the plate-shaped member to relatively move until the plate-shaped member reaches the farther end portion from the predetermined position,
then causing the support portion and the plate-shaped member to relatively move, until the detection signal indicates the non-contact state, such that the plate-shaped member moves upward, and
then controlling the first moving unit and the second moving unit so as to cause the support portion and the plate-shaped member to relatively move in the second direction such that the plate-shaped member approaches the farther end portion.

2. A printing apparatus, comprising:
a support portion that supports a medium;
a discharge unit that discharges ink onto the medium supported by the support portion:
a carriage that holds the discharge unit;
a carriage rail that supports the carriage;
a plate-shaped member, at least a part of which is located downward in a vertical direction of the carriage rail, the plate-shaped member extending in a first direction orthogonal to the vertical direction;
a first moving unit that causes the support portion and the plate-shaped member to relatively move in the vertical direction;
a second moving unit that causes the support portion and the plate-shaped member to relatively move in a second direction orthogonal to the vertical direction and the first direction;
a plate-shaped member support portion that supports the plate-shaped member,
a detection unit that outputs a detection signal configured to identify a contact state and a non-contact state of the plate-shaped member with any member other than the plate-shaped member support portion, or the medium, and
a control unit configured to control the first moving unit and the second moving unit, wherein
the control unit is configured to cause the plate-shaped member to be in contact with a predetermined position in the support portion,
to then cause the support portion and the plate-shaped member to relatively move, until the detection signal indicates the non-contact state, such that the plate-shaped member moves upward in the vertical direction,
to then cause the support portion and the plate-shaped member to relatively move in the second direction until the plate-shaped member reaches, from the predetermined position in the support portion, a farther end portion in the second direction of the support portion from the predetermined position, and to cause the support portion and the plate-shaped member to stop relatively moving each time the detection signal indicates the contact state while causing the support portion and the plate-shaped member to relatively move until the plate-shaped member reaches the farther end portion from the predetermined position,
to then cause the support portion and the plate-shaped member to relatively move, until the detection signal indicates the non-contact state, such that the plate-shaped member moves upward, and
to then control the first moving unit and the second moving unit so as to cause the support portion and the plate-shaped member to relatively move in the second direction such that the plate-shaped member approaches the farther end portion.

3. The printing apparatus according to claim 2, wherein
the first moving unit is configured to cause, the support portion to move in the vertical direction, and to cause, when causing the support portion and the plate-shaped member to relatively move, the support portion to move downward in the vertical direction such that the plate-shaped member moves upward.

4. The printing apparatus according to claim 2, wherein
the second moving unit is configured to cause the plate-shaped member support portion to move in the second direction, and causes, when causing the support portion and the plate-shaped member to relatively move until the plate-shaped member reaches, from the predetermined position in the support portion, the farther end portion in the second direction of the support portion from the predetermined position, the plate-shaped member support portion to move in the second direction from the predetermined position to the farther end portion.

5. The printing apparatus according to claim 2, wherein
the carriage includes a first region closer to the carriage rail and a second region farther from the carriage rail than the first region in the second direction, where a bottom portion in the first region is located farther from the support portion than a bottom portion in the second region, a nozzle face of the discharge unit is located in the second region, and the plate-shaped member is located downward in the vertical direction of the bottom portion in the first region.
